(19) United States
(12) Patent Application Publication
(10) Pub. No.: US 2013/0283101 A1
(43) Pub. Date: Oct. 24, 2013

(54) Trace-Driven Verification of Multithreaded Programs Using SMT-Based Analysis

(71) Applicant: WESTERN MICHIGAN UNIVERSITY RESEARCH FOUNDATION, Kalamazoo, MI (US)

(72) Inventors: Zijiang Yang, Northville, MI (US); Karem Sakallah, Ann Arbor, MI (US); Mahmoud Said, Irbid (JO)

(73) Assignees: The Regents of the University of Michigan, Ann Arbor, MI (US); Western Michigan University Research Foundation, Kalamazoo, MI (US)

(21) Appl. No.: 13/864,804

(22) Filed: Apr. 17, 2013

Related U.S. Application Data
(60) Provisional application No. 61/635,133, filed on Apr. 18, 2012.

(51) Int. Cl. G06F 11/36

(52) U.S. Cl. CPC G06F 11/3612
USPC 714/37

(57) ABSTRACT

The method of testing for presence of a bug a multithreaded computer program under verification combines the efficiency of testing with the reasoning power of satisfiability modulo theory (SMT) solvers for the verification of multithreaded programs under a user specified test vector. The method performs dynamic executions to obtain both under- and over-approximations of the program, represented as quantifier-free first order logic formulas. The formulas are then analyzed by an SMT solver which implicitly considers all possible thread interleavings. The symbolic analysis may return the following results: (1) it reports a real bug, (2) it proves that the program has no bug under the given input, or (3) it remains inconclusive because the analysis is based on abstractions. In the last case, a refinement procedure is presented that uses symbolic analysis to guide further executions.

### CROSS-REFERENCE TO RELATED APPLICATION

This application claims priority to U.S. Provisional application Ser. No. 61/635,133, entitled “GENERATING DATA RACE WITNESSES BY AN SMT-BASED ANALYSIS,” the full text and disclosure of which is hereby incorporated by reference.

### GOVERNMENT RIGHTS

This invention was made with Government support under CCF-0811287 awarded by The National Science Foundation. The Government has certain rights in the invention.

### FIELD OF THE DISCLOSURE

This disclosure relates generally to computer-implemented systems and methods for testing multithreaded computer programs.

### BACKGROUND

One of the main challenges in testing multithreaded programs is that the absence of bugs in a particular execution does not necessarily imply error-free operation under that input. To completely verify program behavior for a given test input, all executions permissible under that input must be examined. However, this is often an infeasible task considering the exponentially large number of possible interleavings of a typical multithreaded program. A program with n threads, each executing k statements, can have up to (nk)!/(k!)ⁿ≧(n!)^{k} thread interleavings, a dependence that is exponential in both n and k.

### SUMMARY

The present disclosure addresses this challenge by an approach we call trace-driven verification (TDV) that combines the efficiency of testing with the reasoning power of satisfiability modulo theory (SMT) solvers. The disclosed trace-driven verification performs dynamic executions to obtain approximations, represented as quantifier-free first order logic (FOL) formulas, of the program under verification. The formulas are then analyzed by an SMT solver which implicitly considers all possible thread interleavings. The symbolic analysis may return one of the following results: (1) it reports a real bug, (2) it proves that the program has no bug under the given input, or (3) it remains inconclusive because the analysis is based on abstractions. In the last case, we present a refinement procedure that uses symbolic analysis to guide further executions. Our disclosed trace-driven verification technique offers these and other advantages:
Implicit consideration of thread interleavings. As explicit enumeration of executions is intractable, the alternative we present is to capture thread interleavings implicitly as a set of constraints in a satisfiability formula. These constraints belong to the family of quantifier-free first order logic formulas for which efficient SMT solvers are available.
Integration of dynamic executions and symbolic analysis. At any given time, trace-driven verification analyzes only the statements that appear in a particular execution under a user-specified test vector. It may report a real bug, or prove that the program behaves as expected under all thread interleavings stimulated by the given input. In either case, trace-driven verification avoids the analysis of statements that do not appear in an execution. However, it is also possible that the symbolic analysis, being an abstraction of program behavior, re-mains inconclusive. In such a case, trace-driven verification uses the symbolic analysis result to guide future concrete executions.
Abstraction with both under- and over-approximations. Based on an execution, trace-driven verification infers both under- and over-approximations of the entire program. The under-approximation is complete so that any bug detected in the model is a real bug; while the over-approximation is sound so that it can be used to prove the absence of bugs.

The trace-driven verification technique does more than merely establish that a multithreaded program error exists. It is a computer-implemented system and method that provides witnesses to help programmers deterministically reproduce the reported multithreaded program error during actual program executions. These witnesses are outputs of the system and method that provide a concrete thread schedule of the program execution that leads to a program state in which the error occurs. The programmer can consult this output and determine the exact place in the multithreaded program that gave rise to the error.

In accordance with one aspect, the disclosed method of testing for presence of a bug a multithreaded computer program under verification, involves these computer-implemented steps. A computer executes the multithreaded program under verification under predefined input conditions and constructs a trace comprising a sequence of events performed by the computer during execution of the multithreaded program under verification. The trace is computer-encoded as a first order logic formula that is stored in memory. The computer then accesses the first order logic formula stored in memory and applies a satisfiability modulo theory (SMT) solver to the first order logic formula to determine if the first order logic formula is solvable. If the first order logic formula is found solvable, the computer generates a report that a bug is present in the multithreaded program under verification. Both under-approximation and over-approximation encoding constraints are possible.

The step of encoding the trace as a first order logic formula may include at least one of the following under-approximation encoding constraints: a) a program transition constraint that expresses the effect of executing a particular statement of the multithreaded program under verification by a particular thread; b) an initial condition constraint that specifies the starting locations for each thread of the multithreaded program under verification as well as the initial values of program variables; c) a trace enforcement constraint that restricts the encoded behavior to include only the statements appearing in an executed trace; d) a thread control constraint that insures that the local state of a thread remains unchanged when the thread is not executing; e) a thread control constraint that insures that the local state of a thread cannot be selected for execution after it has terminated; and f) a property constraint that indicates the correctness conditions expressed as assertions within the multithreaded program under verification.

In addition the step of encoding the trace may include at least one of the following over-approximation encoding steps: a) using a computer to remove a trace enforcement step that prohibits any trace from being considered; b) using a computer to collapse multiple occurrences and thereby consider only one instance in a transition constraint; c) using a computer to add control flow constraints for unexecuted statements.

The disclosed method can be extended to support analysis-guided execution. In accordance therewith, if the first order logic formula is not solvable by the SMT solver, the computer performs additional steps. The computer to encodes the trace as a different first order logic formula stored in memory using an over-approximation formula and then applies the SMT solver to that different first order logic formula to determine if the different first order logic formula is solvable. If solvable, the computer executes the multithreaded program under verification under a thread schedule that differs from the thread schedule used when the different first order logic formula was found solvable by the SMT solver. The process can repeated multiple times until all thread schedules have been exploited.

For a more complete understanding of the disclosed computer-implemented methods and apparatus, refer to the following specification and the accompanying drawings.

### BRIEF DESCRIPTION OF THE DRAWINGS

FIG. 1 is a memory diagram useful in explaining the data race condition;

FIG. 2 is an operating system layer diagram useful in understanding the cause of the data race condition;

FIG. 3 is an exemplary multithreaded computer program useful in explaining a first algorithm embodiment according to the trace-driven verification technique;

FIG. 4 is a table showing the thread interleavings extant in the program illustrated in FIG. 3;

FIG. 5 is a flow diagram illustrating the trace-driven verification technique;

FIG. 6 is a block diagram of a computer with programmed instructions to carry out the trace-driven verification technique;

FIG. 7 illustrates the encoding for different types of tuples according to the trace-driven verification technique;

FIG. 8 depicts an exemplary program under verification with recursion and dynamically created threads;

FIG. 9 is a table showing the results produced by the illustrative example of FIG. 8;

FIG. 10 is a table comparing bounded model checking (BMC), trace-driven verification (TDV) and trace-driven verification with optimizations (TDVO);

FIG. 11 is an exemplary Java program with data races;

FIG. 12 illustrates an execution trace of the Java program of FIG. 10 with initial value x=0;

FIG. 13 is a table showing recursive-lock-free synchronization inconsistency interpretation;

FIG. 14 is a table showing recursive-lock-free synchronization consistency encoding;

FIG. 15 is a depiction of two threads executing with shared variables x,y; and

FIG. 16 is a table depicting performance of the symbolic data race witness generation algorithm.

### DESCRIPTION OF PREFERRED EMBODIMENTS

### Discussion of the Data Race Condition in Multithreaded Programs

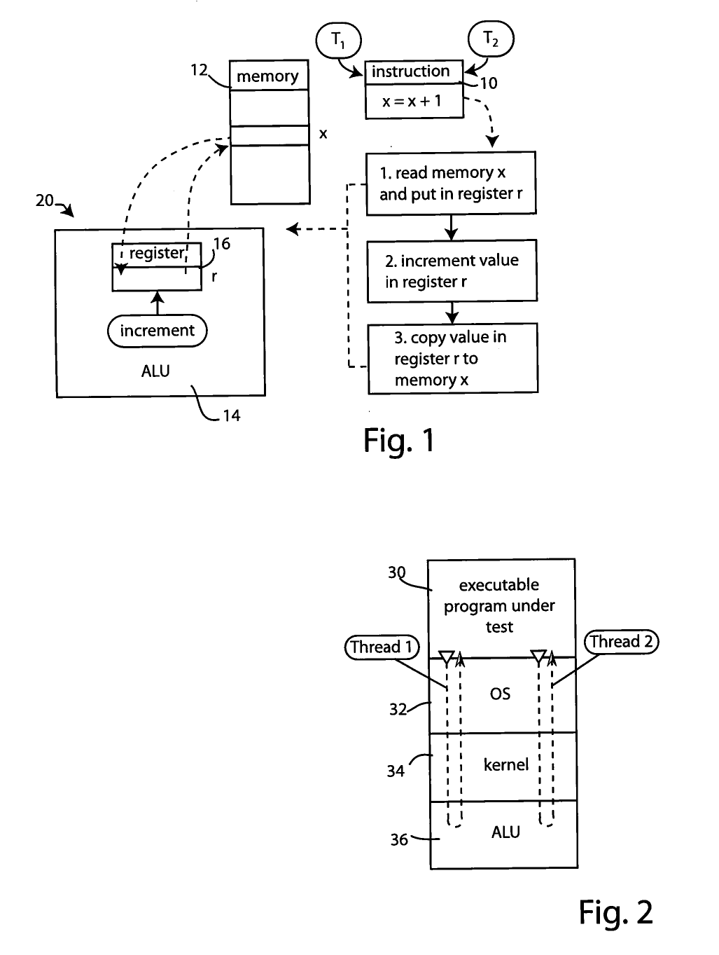

In multithreaded programs the programmer must take care to control how and when two or more executing threads are allowed to access the same shared memory location. An error known as a data race condition occurs where two threads access the same memory location with no ordering constraints enforced between them, and where at least one of the threads is writing data to that memory location. FIG. 1 illustrates the problem.

FIG. 1 assumes, by way of example, that the statement of a multithreaded program being executed is incrementing the value stored in memory location x, that is (x=x+1). The instruction x=x+1 is shown for reference at 10. A portion of memory that includes location x is shown at 12. FIG. 1 further assumes that two threads T1 and T2 are both executing this statement, and are thus both attempting to increment the value stored in x.

The actual process by which memory location x is updated involves operations performed by the arithmetic logic unit (ALU) 14 of processor 20. The processor 20 first copies the value stored in x into one of its internal registers 16. The ALU 14 then executes the increment instruction stored as part of the ALU's microcode. The incremented value in register 16 is then written back to memory location x. With this basic operation in mind, we now consider what happens when threads T1 and T2 both execute instruction 10. Let us assume that the initial value stored in memory location x is 0.

One might assume that if both threads execute the instruction x=x+1, then the final value in memory x would be 2 (1+1). Such would be the case if thread T1 has executed to completion before thread T2 starts. However, with multithreaded programs it is possible that threads T1 and T2 will be interleaved. To illustrate, imagine that T1 begins first, copying the value x into register 16 and then increments the value in the register (r=1). Before having a chance to copy the register value back to memory x, T2 begins and copies the value x into register 16. The value in register 16 now contains 0 (r=0). Thread T1 then copies the value in register 16 (now storing 0) back to memory x. Thereafter T2 then increments the value in the register (r=1). T2 then copies the register value back to memory x, resulting in memory x storing the value 1 (x=1).

The data race condition illustrated in FIG. 1 results from the reality that neither thread is in complete control of the timing associated with the processor's internal operations. The reason for this is illustrated in FIG. 2. As both threads execute, the internal operations of moving data from memory, into the ALU registers, and back, involves a series of operating system control handoffs, as control is passed from the executable code layer 30, through the operating system layer 32 and kernel layer 34, and then ultimately passed to the ALU layer 36 where microcode instructions actually cause the data to be read from memory 12, copied to register 16, incremented in register 16, and written back to memory 12. As control is handed off to successively lower layers and back, other processes may also be running that could temporarily suspend operation one or the other (or both) of the respective threads.

The data race condition described above, which caused the value in x to be 1 instead of 2, could be the result, for example, of the operating system momentarily diverting its attention to handle an external event, such as responding to a user's mouse click, or launching a routine housekeeping process to delete a memory cache. From the program designer's viewpoint these data race conditions are insidiously difficult to troubleshoot, because they can occur (or not) even when care has been taken to set all values exactly the same from test to test. Because the program designer is ultimately unable to control the timing of how and when the program instructions will be carried out, and thus unable to reproduce precisely how internal events may occur from test to test, it is virtually impossible to track down a data race culprit by conventional testing.

Discussion of Other Sources of Error within Multithreaded Programs

Multithreaded programs can exhibit other errors besides the data race condition. These include atomicity violations, order violations and assertion failures. Atomicity violations involve situations where two or more operations need to be executed together or not at all. In other words the two operations appear indivisible or “atomic” to the rest of the system. For example, when wife makes an ATM deposit (operation one) and then immediately checks the bank balance (operation two) she expects to see the balance as having been increased by the amount of the deposit. An atomicity violation occurs when these two purportedly atomic operations are severed, as when a foreign operation is interleaved between them. Thus in the example, if while the wife is making her deposit, her husband withdraws money from a different ATM machine (operation three), using the same account and access code, resulting in a reduction in the balance unexpected by the wife. The wife infers the ATM has failed to properly register her deposit, when in fact an atomicity violation has occurred. The preferable ATM system behavior would be to keep deposit (operation one) and balance check (operation two) indivisibly connected.

Order violations involve situations where one operation must occur before another, but the order of the two operations are reversed in error. For example, a computer program may need to allocate memory to store a pointer before that pointer can be used. If an attempt to use the pointer occurs before memory has been allocated for it, an order violation error has occurred.

In some computer languages the programmer can insert a predicate (a true-false statement) in the program to indicate the programmer's expectation that the predicate is always true at that place. Assertion failure occurs when the assertion evaluates to false. Assertions can be used at runtime, or sometimes statically, to abort execution. Programmers use assertions to help debug programs. When inserted at the beginning as a precondition, the assertion determines the states under which the programmer expects the code to execute. When inserted at the end as a postcondition, the assertion describes the expected state at the end of program execution.

### Algorithm Overview

The trace-driven verification technique described here is a computer-implemented method and apparatus that accepts a multithreaded program under verification as input. It then tests that multithreaded program by executing it while storing a trace history or trace log of the steps or events that executed. The trace history is stored in memory and then processed by the computer to encode it as a first order linear formula that is also stored in memory. The first order linear formula is then fed as input to a further computer-implemented process known as a satisfiability modulo theory (SMT) solver. The solver attempts to see if there is a solution to the first order linear formula that has been generated based on the trace history that was captured. If the SMT solver finds a solution, that is an indication that the multithreaded program contains a bug.

Consider a multithreaded program P under verification, where threads communicate via shared variables, as was illustrated in FIG. 1. Without loss of generality, we assume for explanation here that there is at most one shared variable access at a program statement. If there are multiple shared variable accesses in one statement, we can introduce additional local variables and split the statement into multiple statements such that each statement has at most one shared variable. For example, consider a statement a=x+y with shared variables x, y and local variable a. It can be split into two statements t=y and a=x+t with the help of a temporary local variable t. Then each statement constitutes an atomic computational step, at which granularity the thread scheduler can switch control between threads during the execution.

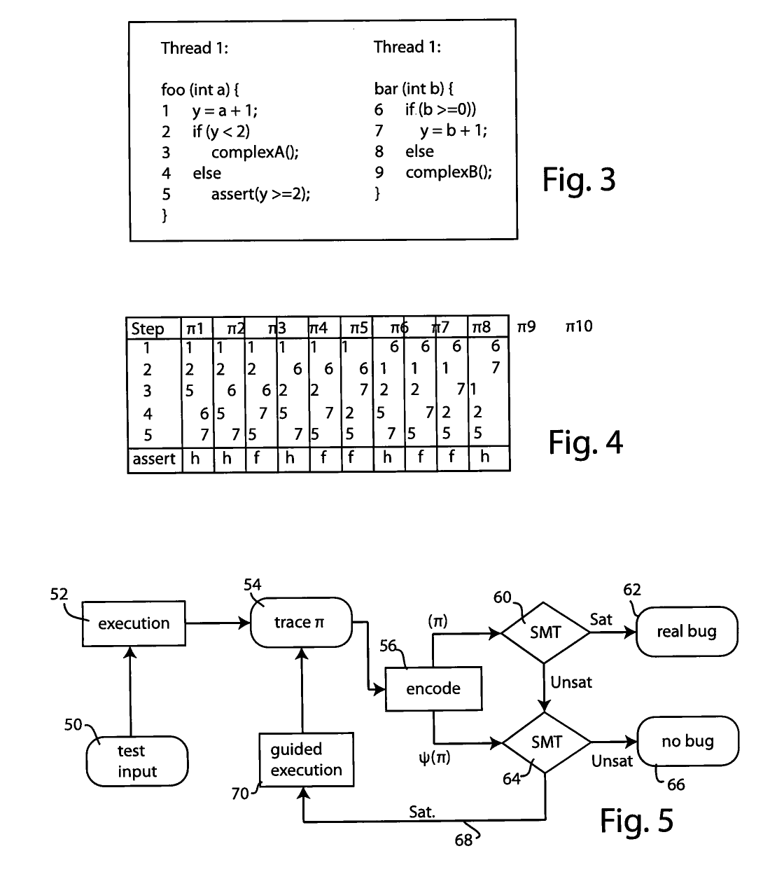

Consider the program, shown in FIG. 3, that consists of two concurrently running threads. In a typical testing environment, even if we run the program multiple times under the test input a=1, b=0, we may obtain the same executed trace π₁= [symbol] 1, 2, 5, 6, 7 [symbol] where the integer values indicate the line numbers. In general, an executed trace or execution trace is an ordered sequence of program statements executed by the different threads. More specifically the trace is a sequence of instances of visible operations in a concrete execution of the multithreaded program. Each instance is called an event.

With reference to FIG. 3, although π₁ does not cause an assertion failure on Line 5, we cannot conclude the absence of assertion failures in this program as this input admits other interleavings of these two threads. The table of FIG. 4 shows the set II(π₁) of all 10 possible interleavings of π₁. For each trace in the table, the bottom row indicates whether the assertion on Line 5 holds (h) or fails (f). However, not all the interleavings in II(π₁) are valid executions. Closer examination of π₆ and π₉ shows that they are infeasible traces, due to the violation of program semantics. In particular, after y is updated by Thread 2 on Line 7, it is not possible for Thread 1 to follow the Else branch on Line 2. Let II_{P} (π₁) be the set of interleavings derived from π₁ that are consistent with the semantics of the program P. We have II_{P}(π₁)={π₂, π₃, π₄, π₅, π₇, π₈, π₁₀}. We call a trace πᵢ∈II_{P}(π₁)\{π₁} an induced trace of π₁.

The trace logging can be implemented by capturing data from the executing multithreaded program using an interface, such as an agent interface that captures execution events from the executing program. For example, in the case of a Java program, trace logging may be implemented by capturing the Java Virtual Machine Execution events.

In order to check for assertion failures not only in π₁ but also in its induced traces, we construct a first order linear (FOL) formula φ(π) that implicitly models all the traces in IIₚ(π) (see “Under-Approximation FOL Formula” below for details). A satisfying assignment to φ(π) indicates a true assertion failure and can be used to identify the particular thread interleaving that produces it. If φ(π) is unsatisfiable, however, we cannot conclude correctness because φ(π) is an under-approximation of program behavior. To understand the reason consider a statement assert(C_{complexA}) inside complexA( ) on Line 3 in FIG. 1. Given the executed trace π₁= [symbol] 1, 2, 5, 6, 7 [symbol] , φ(π₁) itself cannot reveal any assertion failure inside complexA( ) since the assert(C_{complexA}) statement does not even appear in any traces of IIₚ(π₁). On the other hand, there exist valid executions that execute complexA( ) (e.g. π′= [symbol] 1, 6, 7, 2, 3, . . . [symbol] ). Thus an assertion failure is still possible under the test input a=1, b=0.

To insure correctness (absence of assertion failures), all execution traces permissible under that input must be examined. We relax, or abstract φ(π), by making changes to and dropping some of its constraints (see “Over-Approximation FOL Formula” below for details). This leads to ψ(π), an FOL formula that represents an over-approximation to the program behavior under the specified input. If ψ(π) is unsatisfiable, we can provably conclude the absence of assertion failures for all thread interleavings under the specified input. Otherwise we need to check if the reported violation is true or spurious. In the latter case, our computer-implemented trace-driven verification (TDV) algorithm performs refinement by modifying the control flow in order to examine other executions of P under the same test input.

As illustrated in FIG. 5, the TDV algorithm consists of the following steps:
1. Run the program (Step 52) under a given user input (test input 50) to obtain an initial execution trace π (shown at 54).
2. Using an encoding such as described below under “Under-Approximation FOL Formula,” construct an FOL formula φ(π), as illustrated at Step 56.
3. Using an SMT solver, check the satisfiability of φ(π). This is shown at SMT step 60 with the real bug determination indicated at 62.
   If φ(π) is found to be satisfiable, a real bug is found. Based on the solution to φ(π) we can report to the user the specific scheduling that exposes the bug (Step 62).
   If φ(π) is found to be unsatisfiable, we relax φ(π) to obtain ψ(π). This allows us to examine sibling traces, i.e., traces that conform to the same input but cover different statements (Step 64).
   If ψ(π) is found to be unsatisfiable (at Step 64), we can conclude that the property holds under all possible thread interleavings under the given test input. The “no bug” result is indicated at 66.
   If ψ(π) is found at Step 64 to be satisfiable, the SMT solver returns a counter-example, as indicated at 68, which is used to guide new executions (Step 70) that are guaranteed to touch new statements that have not appeared in previous executions.

While a variety of different SMT solvers may be used to implement step 60, a suitable solver is the Yices SMT solver, which is capable of deciding formulas with a combination of theories including propositional logic, linear arithmetic, and arrays.

### Symbolic Encoding of Execution Traces

As illustrated in FIG. 5, the encoding step 56 branches to produce two analysis paths that respectively supply inputs to the SMT processing step 60 and the SMT processing step 64, according to the process flow described above. The former path is based on an under-approximation first order logic (FOL) formula φ(π); the later path is based on an over-approximation FOL Formula ψ(π). These respective first order logic encodings are separately discussed below. The processor generates these respective under-approximation and over-approximation FOL encodings using data collected by monitoring and capturing an executed trace or trace log of the program under verification as it runs.

An executed trace is a sequence π= [symbol] (t₁,I₁.o₁,Q₁), . . . , (tₙ,Iₙ,oₙ,Qₙ) [symbol] that lists the statements executed by the various threads. Each tuple (t, I.o, Q)∈π is considered to be an atomic computational step where t is the thread id, I is the line number for the statement, o is an occurrence index that distinguishes the different executions of the same statement, and Q is the statement type that can be one of assign, branch, jump, fork, join or assert. In this description we assume all the executions eventually terminate. For nonterminating programs, our procedure can be used as a bounded analysis tool to search for bugs up to a bonded number of execution steps.

We consider three basic types of statements: assignment v=E where E is an arithmetic expression, branch C?I.o where C is a relational expression, and jump goto I.o. Note that C?I.o only lists the destination if C holds because no two branches can be taken simultaneously in an executed trace. Note that a conditional branch such as “if C then I₁: . . . else I₂: . . . ” results in the executed trace C?I₁ if the then branch is executed, and [symbol] C?I₂ otherwise. Besides the basic types, we also allow assert(C) for checking assertions, exit for signaling the termination of a thread, and the synchronization primitives. fork(t) and join(t) allow a thread to dispatch and wait for the completion of another Thread t. Given a program written in a full-fledged programming language like C, one can use pre-processing to simplify its executed traces into the basic statements described above. For a discussion of suitable pre-processing techniques, reference may be had to F. Ivan\check{c}ić, I. Shlyakhter, A. Gupta, M. Ganai, V. Kahlon, C. Wang, and Z. Yang. Model checking C program using F-Soft. In IEEE International Conference on Computer Design, San Jose, Calif., October 2005.

### Under-Approximation FOL Formula

A key aspect of the computer-implemented trace-driven verification (TDV) algorithm resides in the construction of appropriate first order logic (FOL) formulas that can be easily checked with satisfiability modulo theory (SMT) solvers. One computer-implemented algorithm embodiment for constructing first order logic involves using the computer to analyze the trace associated with a thread and to then generate a set of logic constraints that include the following:
Program Transition constraint;
Initial Condition constraint;
Trace Enforcement constraint;
Thread Control constraint; and
Property Constraint.

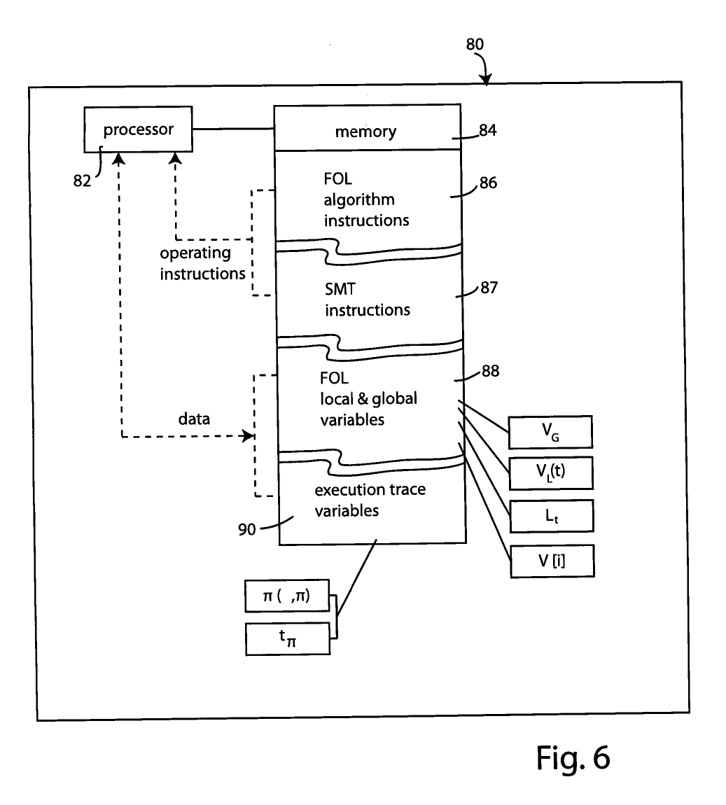

The computer-implemented algorithms to assess and represent these constraints will next be discussed. The algorithms are performed by a computer, using a set of predefined program instructions that access a set of predefined local and global variables that are stored in allocated memory locations accessible to the processor of the computer that generates the first order logic formulas. FIG. 6 shows the basic computer configuration. In FIG. 6 the computer 80 has a processor 82 interactively communicating with memory 84. Memory 84 stores both the program instructions and the local and global variables. Thus, in FIG. 6 the memory 84 includes instructions for performing the first order logic (FOL) algorithm, stored at 86, instructions for implementing a satisfiability modulo theory (SMT) solver 87, and a region of memory allocated at 88 to store the local and global variables corresponding to the program under verification and execution trace location variables for each thread 90.

As will be appreciated, the memory 84 is allocated to separately store variables associated with each thread of a multithreaded program under verification. In this regard, the reader will understand that the program under verification refers to the multithreaded program being tested for errors by the present computer-implemented system. The computer-implemented system itself has its own predefined program instructions that cause the processor 82 to carry out the algorithmic operations described herein. The program under verification and the program that implements the disclosed system are thus different as will be appreciated by those of skill in this art. These respective programs may be run on the same computer, or on separate computers that communicate with one another via a network or other suitable means.

While a wide variety of different computers 80 can be used, we have demonstrated successful results using a computer workstation equipped with a Pentium D 2.8 GHz processor 82, with 4 GB of memory 84, running the Red Hat Linux 7.2 operating system. Those skilled in the art will appreciate that other computers, processors, memory and operating systems may be used.

### Data Structure of Memory 84

Let V_{G} and V_{L}(t) denote the set of global and local variables in Thread t, respectively. These are stored in memory at 88, as illustrated diagrammatically in FIG. 6. Let the set of variables visible to t be V (t)=V_{G}∪V_{L}(t). In addition to program variables, we introduce a statement location variable Lₜ for each thread, whose domain includes all the possible line numbers and occurrence indices. To model nondeterminism in the scheduler, we add a variable T whose domain is the set of thread indices. A transition in Thread t is executed only when T=t. At every transition step we add a fresh copy for each variable. That is, v[i] denotes the copy of v at the i-th step. Given an executed trace π, φ(π) consists of following constraints.

### Computing the Program Transition Constraint

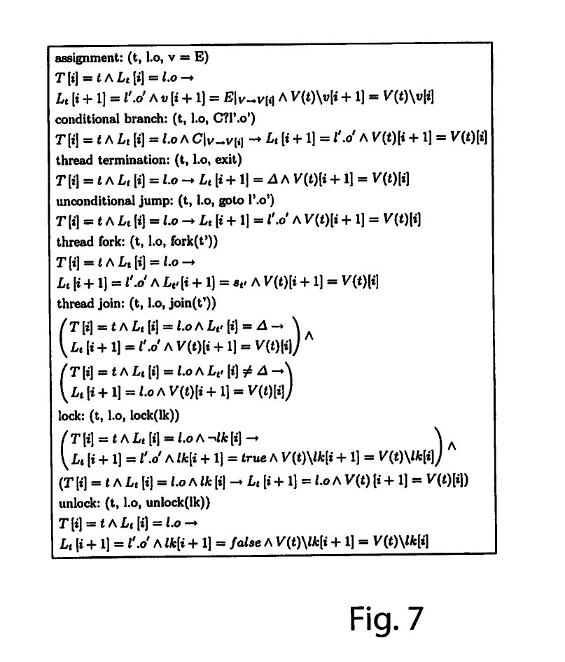

The program transition constraint δ_{π} expresses the effect of executing a particular statement of the program by a particular thread. For each tuple (t, I.o, Q) except when Q is exit, we assume the next tuple to be executed by Thread t is (t, I′.o′, Q′). Once the last tuple (t, I.o, exit) of Thread t has been executed, we use Δ to indicate the end of Thread t. Let δ_{t,I.o}[i] denote the constraints of (t, I.o, Q)∈π at step i. FIG. 7 shows the encoding for different types of tuples. For example, the one for (t, I.o, v=E) states that if Thread t executes the statement at step i, the following updates occur at step i+1:
the next statement for Thread t to execute is I′.o′;
the value of v at step i+1 is E/_{V→V[i]} with all variables in E replaced by their corresponding versions at step i; and
other visible variables remain unchanged.
   The program transition constraint δ_{π} is defined and computed according to Eq. 1 as follows:

$${δ}_{π} ≡ {}_{i = 1}^{\vert π \vert} {}_{( t , l , o )} {δ}_{t , l , o} [ i ] \qquad ( Eq . 1 )$$

### Storing the Initial Condition Constraint

The initial condition constraint ι_{π}specifies the starting locations for each thread as well the initial values of program variables, including the values set by the input vector. These are stored in memory as at 90.

### Computing the Trace Enforcement Constraint

The trace enforcement constraint ε_{π} restricts the encoded behavior to include only the statements appearing in an executed trace π. For each (t, I.o, C?I′o′)∈π we assume condition C holds on line I at o-th occurrence in π. The trace enforcement constraint is thus calculated according to Eq. 2 as follows:

$${ɛ}_{π} ≡ {}_{i = 1}^{\vert π \vert} {}_{( t , l , o )} ( T [ i ] = t ⋀ L [ i ] = l , o \to C {\vert}_{v v [ i ]} ) \qquad ( Eq . 2 )$$

### Computing the Thread Control Constraint

The thread control constraint τ_{π} serves two functions. First, it insures that the local state of a thread (the values of its local variables) remains unchanged when the thread is not executing. Second, it insures that the thread cannot be selected for execution after it has terminated. These two constraints are defined and computed as specified in Eq. 3 as follows:

τ_{i,idle}[i]≡T[i]≠t→Lₜ[i+1]=Lₜ[i] [symbol] V_{L}(t)[i+1]=V_{L}(t)[i]

τ_{t,done}[i]≡Lₜ[i]=Δ→T[i]≠t (Eq. 3)

The thread control constraint is then defined and computed according to Eq. 4 as follows:

$${τ}_{π} ≡ {}_{i = 1}^{\vert π \vert} {{}_{( t , l , o )}}^{N} ( {τ}_{t , idle} [ i ] ⋀ {τ}_{t , done} [ i ] ⋀ {τ}_{other} ) \qquad ( Eq . 4 )$$

In the above Eq. 4, the term τₒₜₕₑᵣ, represents additional optional constraints that can be included to model particular scheduling policy.

### Computing the Property Constraint

The property constraint ρ_{P} indicates the correctness conditions, specified as assertions within the program under verification that we would like to check for validity under all possible executions. Note that many common programming errors can be modeled as assertions. Let (t, I, assert(C)) be an assertion on line I in Thread t. The property constraint can be defined and computed as specified in Eq. 5 as follows:

$${ρ}_{P} ≡ {}_{i = 1}^{\vert π \vert} {}_{( t , l )} ( T [ i ] = t ⋀ L [ i ] = l \to C {\vert}_{{V}_{c} \to {V}_{c} [ i ]} ) \qquad ( Eq . 5 )$$

Note that properties encoded by ρ_{P} are not necessarily the assertions appearing in π only; the assertions may appear anywhere in the program P under verification. This is an important requirement for our trace-based method to find real failures anywhere in the program, or to prove the absence of assertion failures of the program.

Whether the property ρ_{P} holds for all possible thread interleavings in II_{P}(π) is determined by checking the validity of the formula: ι_{π} [symbol] δ_{π} [symbol] τ_{π} [symbol] ε_{π}→ρ_{P}, which is equivalent to checking the satisfiability of the formula stated in Eq. 6:

φ(π)≡ι_{π} [symbol] δ_{π} [symbol] τ_{π} [symbol] ε_{π} [symbol] [symbol] τ_{P} (Eq. 6)

Equation 6, which implicitly represents all thread interleavings of II_{P} (π), is still an under-approximation of the behavior of program P under the given test input. Therefore, a solution to φ(π) reveals real errors in the program, but the unsatisfiability of φ(π) does not prove the absence of errors.

### Over-Approximation FOL Formula

Let II_{P} (\vec{ν}) be the set of all possible execution traces of program P under the test input \vec{ν}. The set of interleavings considered by φ(π) is II_{P} (π) [symbol] II_{P} (\vec{ν}).

To catch assertion violations in branches not yet executed in π, or to establish the absence of such violations in all traces, we need an over-approximation of II_{P} (\vec{ν}). The over-approximated encoding can be obtained from φ(π) with the following changes:
Remove the trace enforcement constraint ε_{π} that prohibits any trace π′∉II_{P} (π) from being considered in φ(π). In FIG. 1, for example, a trace starting from [symbol] 1, 6, 7, 2, 3, . . . [symbol] can be a valid execution according to the program. However, the ε_{π} constraint T [i]=1 [symbol] L[i]=2→y[i]≧2 prohibits the trace from being considered.
Collapse multiple occurrences. For statements that occur more than once, we consider only one instance in the transition constraint. Thus the occurrence index o is no longer needed. This leads to a modified transition constraint δ_{π}^{o}.
Add control flow constraints λ_{π} for un-executed statements. λ_{π} keeps the control flow logic but ignores the data logic in those statements that do not occur in π. The purpose of λ_{π} is to force the over-approximated behavior to at least follow the control flow logic of program P. Here we consider assignments and conditional branches. Given a conditional branch (t,I,C?I1:I2)∉π that executes I₁ next if C is true and I₂ next otherwise, we add a constraint to λ_{π} [i]:

T[i]=t [symbol] Lₜ[i]=l→Lₜ[i+1]=l₁ [symbol] Lₜ[i+1]=l₂ (Eq. 7)

Similarly, for an assignment statement (t, l, v=E)∉π that executes I₁ next, the constraint added to λ_{π}[i] is

T[i]=t [symbol] Lₜ[i]=l→Lₜ[i+1]=l₁ (Eq. 8)

After the modifications above we obtain the following over-approximation:

ψ(π)≡ι_{π} [symbol] δ_{π}^{o} [symbol] τ_{π} [symbol] λ_{π} [symbol] [symbol] ρ_{P} (Eq. 9)

Let Ω(π) be the set of interleavings considered by ψ_{π}; then Ω(π) [symbol] II_{P} (\vec{ν}) is an over-approximation of the program behavior under the test vector \vec{ν}. In general, the unsatisfiability of ψ(π) proves P has no assertion failures under the test vector \vec{ν}. The downside of using ψ(π) is the inevitability of invalid executions which need to be filtered out afterwards. In the running example in FIG. 3, the SMT solver may report π₆ in the table of FIG. 4 as a satisfiable solution of ψ(π). However, it is not a feasible trace since the behavior of the step in line 2 is unspecified in ψ(π) when y<2.

### Analysis-Guided Execution

As was shown in FIG. 5, the trace-driven verification flow can included a guided execution step 70 that can refine the analysis of multithreaded programs. Through guided execution the computer-implemented verification process is able to validate potential counterexamples, and to generate new execution traces for further analysis.

To illustrate how the guided execution step 70 is implemented, let CEX_{π} be a satisfiable assignment to all variables in ψ(π); it is called a potential counterexample. In the counterexample guided abstraction refinement (CEGAR) framework, a decision procedure (theorem prover, satisfiability (SAT) solver, or binary decision diagrams BDDs) may be used to check whether CEX_{π} is feasible in P, and if not, to refine the over-approximation. Such an approach may not be scalable for handling multithreaded software due to the program complexity and the length of the counterexamples.

Instead, we presently prefer to use guided concrete execution rather than a theorem prover or a SAT solver. Let T=∪ᵢ₌₁^{|π|} {T[i]} be the set of thread selection variables at all time steps, and let L=∪ᵢ₌₁^{|π|} ∪ₜ₌₁^{N} {Lₜ[i]} be the set of line number variables. Given CEX_{π}, we first extract a thread schedule SCH_{π}=∃_{v∈{T∪L}}. CEX_{π}, and organize it as a sequence:

π_{SCH}= [symbol] (t₁,l₁),(t₂,l₂), . . . ,(t_{|π|},l_{|π|})

[symbol]

Note that the occurrence index is not needed as the sequence uniquely identifies a trace (although it may be infeasible). The program is then re-executed by trying to follow π_{SCH}; this is implemented by using check-point and restart techniques as in [30]. If the re-execution can follow π_{SCH} to completion, then π_{SCH} represents a real bug. Otherwise, we obtain a new executed trace:

π′= [symbol] (t₁,l₁,o₁), . . . ,(tₖ₋₁,lₖ₋₁,oₖ₋₁),(tₖ′,l_{k′},oₖ′), . . . ,(t_{|π′|}′,l_{|π′|}′,o_{|π′|}′)

[symbol]

In the above statement, π and π′ have the same thread ids and line numbers for the first k−1 steps. But starting from the k-th step π′ can no longer follow π and completes the execution on its own.

To sum up, by performing a guided execution after analyzing the over-approximation ψ(π), we are able to either validate the potential counterexample CEX_{π}, or obtain a new execution π′ for a further analysis.

### Avoid Redundant Checks

To avoid performing symbolic analysis on executed traces that have been analyzed before, we maintain a set χ of already inspected traces. Let {π₁, . . . , πₘ} be the set of executed traces in the first m iterations that have been analyzed. If ψ(πₘ) is satisfiable, we are only interested in a solution \vec{S} such that the trace π_{\vec{S}} corresponding to \vec{S} satisfies π_{\vec{S}}∈II_{P} (πᵢ) for all 1≦i≦m. Such requirement is not only for performance, but also for the termination of the algorithm: without χ our algorithm may analyze the same executed trace infinitely.

Let πₜ be a subsequence of π that is executed by Thread t. For two such subsequences πₜ¹ and πₜ² from two different executed traces, if they visit the same set of branch statements in t and have the same truth value of the conditionals at each branch, then πₜ¹≡πₜ² (same statements are visited in the same order). Therefore, the trace enforcement constraint ε_{π}_{ₜ} uniquely identifies a trace πₜ in Thread t. As II_{P} (π) is the interleavings among the traces πₜ_{₁}, . . . , πₜ_{_{N}}, they are identified by ε_{π}=ε_{π}_{ₜ₁} [symbol] . . . [symbol] ε_{π}_{_{tN}}. In other words, in order to find a trace not in II_{P}(π), we must add the constraint [symbol] ε_{π}. Assume {π₁, . . . , πₘ} are the traces that have been executed so far, we have

$${χ}_{m} ≡ {{}_{k = 1}}^{m} {ɛ}_{{π}_{k}} \qquad ( Eq . 10 )$$

The over-approximation formula at the (m+1)-th iteration becomes

ψ(π)≡ι_{π} [symbol] δ_{π}^{o} [symbol] τ_{π} [symbol] λ_{π} [symbol] χₘ [symbol] [symbol] ρ_{P} (Eq. 11)

### Illustrative Example

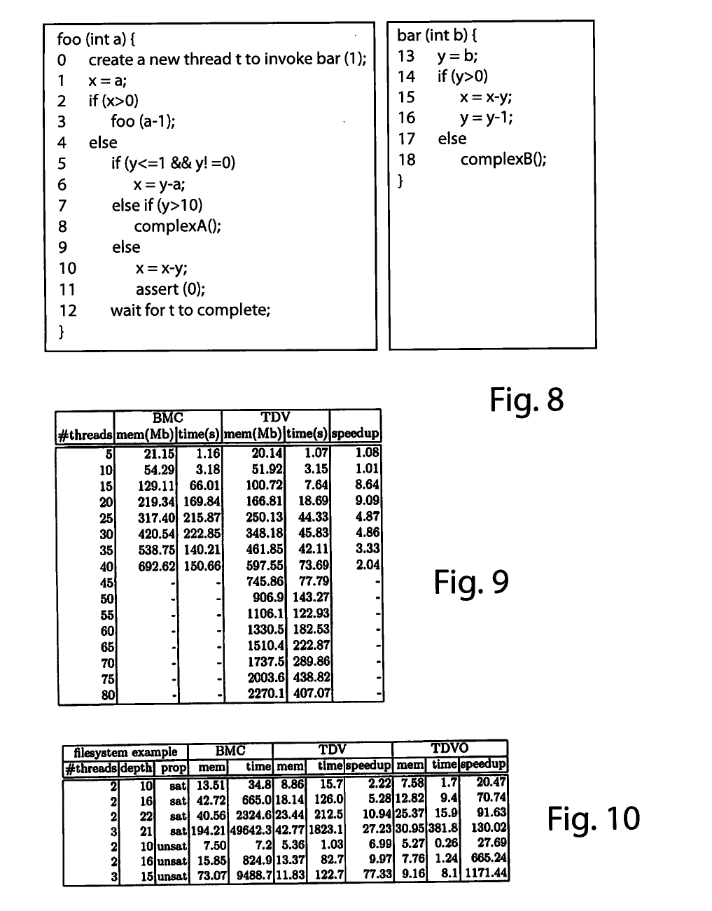

FIG. 8 shows a program with two methods foo and bar. At Line 0 foo creates a new thread and invoke bar. There is a recursive call on Line 3 in foo, therefore, multiple threads may be created depending on the input value of a. In the program, x and y are global variables with initial value 1, while a and b are thread local variables. We would like to check whether there can be an assertion failure on Line 11 under the test value a=1.

Assume the first executed trace is π₁= [symbol] (1, 0.1), (1, 1.1), (1, 2.1), (1, 3), (1, 0.2), (1, 1.2), (1, 2.2), (1, 5), (1, 6), (2, 13), (2, 14), (2, 15), (2, 16), (3, 13), (3, 14), (3, 15), (3, 16), (1, 12.1), (1, 12.2) [symbol] , in which Thread 1 creates Thread 2 and 3 that execute bar(1). Note that in π₁ we drop the occurrence index if a statement of a thread occurs only once. An under-approximated symbolic analysis on π₁ does not yield an assertion violation, but the over-approximated symbolic analysis produces a counter-example: CEX₁= [symbol] (1, 0), (1, 1), (2, 13), (2, 14), (2, 15), (1, 2), (1, 5), (1, 7), (1, 10), (1, 11) [symbol] , which leads to an assertion failure on Line 11. An execution following CEX₁ shows that the counterexample is spurious as it can only follow up to (1,5), because the else branch on Line 5 cannot be taken. The complete executed trace is π₂= [symbol] (1, 0), (1, 1), (2, 13), (2, 14), (2, 15), (1, 2), (1, 5), (1, 6), (2, 16), (1, 12) [symbol] . There is no assertion failure in π₂, but the counterexample obtained from the over-approximated analysis is CEX₂= [symbol] (1, 0), (1, 1), (2, 13), (2, 14), (2, 15), (2,16),(1,2),(1,5),(1,7),(1,10),(1,11) [symbol] . A further execution is able to follow the complete trace of CEX₂ and therefore reveals a real assertion failure on line 11.

Using the Yices SMT solver to implement steps 60 and 64 (FIG. 5), the program illustrated in FIG. 8 produced the results shown in the table of FIG. 9. By changing the value of the test variable a, we can increase the number of threads and the level of recursion. In FIG. 9, Column 1 lists the number of threads. Columns 2 and 3 show the peak memory and total time usage for Bounded Model Checking (BMC) without dynamic execution and abstraction. Columns 4 and 5 show the peak memory and total time usage for TDV. Note that optimizations has been applied to both methods. The last Column shows the speedup of the new method. A one-hour timeout limit is used in all the experiments. BMC ran out of time for test cases with more than 50 threads, while our method took only 407 seconds to complete 80 threads.

We also performed the experiments on the file system example, which is derived from a synchronization idiom found in the Frangipani file system. The table of FIG. 10 shows the results we obtained by comparing BMC and TDV, both without and with optimizations. The results show that TDV gains a speedup from 1.46 to 77.33 over BMC, and the TDV with optimizations gains a speedup from 5.87 to 1171.44 over BMC, with an average speedup of 299.

### Optimizations

If desired the system can be configured to apply peephole partial order reduction (PPOR) to exploit the equivalence of interleavings due to independent transitions. Unlike classical partial order reduction, peephole partial order reduction is able to reduce the search space symbolically in an SMT solver.

Given an executed trace π= [symbol] (t₁, I₁.o₁, Q₁), . . . , (tₙ, Iₙ.oₙ, Qₙ) [symbol] , we add a special scheduling constraint for every pair of tuples (tₚ,Iₚ.oₚ,Qₚ) and (tₚ,Iₚ.oₚ,Qₚ) such that tₚ≠t_{q} and Qₚ and Q_{q} are not dependent. Two statements are dependent if they access the same shared variable and at least one access is a write. For example, consider two statements Qₚ: a[k1]=e₁ and Q_{q}: a[k2]=e₂ that are independent if the array index expressions do not have the same value. We add the following constraint to φ(π).

Lₚ[i]=lₚ,oₚ [symbol] L_{q}[i]=l_{q},o_{q} [symbol] k1|_{V→V[i]}≠k2|_{V→V[i]}→ [symbol] (T[i]=q [symbol] T[i+1]=p) (Eq. 12)

which prohibits Qₚ being executed immediately after Q_{q}. Similar constraints can be added to over-approximated satisfiability formula ψ(π).

Another optimization is a new thread-local static single assignment (TL-SSA) form to efficiently encode the thread-local statements. TL-SSA can significantly reduce the number of variables and the number of constraints needed in φ(π) and ψ(π), which are crucial since they often directly affect the performance of an SMT solver. Our observation is that the encoding step 56 (FIG. 5) may produce many redundant variables and constraints, due to the fact that it has to assign a fresh copy to every variable at every step. However, statements involving only local variables do not need a fresh copy of the local variables and constraints at every step. Furthermore, in a typical program execution, each statement writes to one variable at a time; a vast number of constraints, in the form of v[i+1]=v[i], are used to keep the current values of the uninvolved variables.

In a purely sequential program, one can use Static Single Assignment (SSA) form to simplify the encoding of a SAT formula. However, SSA is not meant to be used in multithreaded programs (it remains an open problem as to what a SSA-style IR should be for concurrent programs), since a use-define chain for any shared variable cannot be established at compile time. Our observation here is that, while shared global variables cannot take advantages of the SSA form, local variables can still utilize the reduction power of SSA. The proposed TL-SSA form exploits the fact that, in any particular execution trace, the use-define chain of every local variable can be determined. Consider an executed trace snippet [symbol] . . . (y=a+1), . . . , (a=y), . . . , (y=y+a) [symbol] , where y is a shared variable and a is a local variables. In addition, no other statements in the trace access a. The trace with corresponding sequence of TL-SSA statements are [symbol] . . . (y=a₀+1), . . . , (a₁=y), . . . , (y=y+a₁) [symbol] . Instead of creating fresh copies for local variables at every step, the TL-SSA form creates only two copies of a. In addition, there is no need for the constraints a[i+1]=a[i] to keep the value of a at each step where a is not assigned.

### Java-Optimized Embodiment

In the preceding discussion no specific assumption has been made about the multithreaded program under verification. It is possible, however, to optimize the basic algorithm shown in FIG. 5 to work with programs under verification that are written in specific programming languages. To illustrate how this may be done, the following will explain how the algorithm can be optimized for the Java language. For illustration purposes the discussion will focus on the data race property. More specifically, it will be shown how the Java syntax can be converted to low level formula suitable for processing by the SMT solver.

Multithreaded Trace in a Java program

Here we consider a multithreaded Java program as a set of concurrently running threads, and use Tid={1, . . . , n} to denote the set of thread indices. The operations on global or shared variables are called visible operations, while those on thread-local variables are called invisible operations. In particular, synchronization primitives such as operations on locks and condition variables are regarded as visible operations.

### Execution Traces

As explained above, an execution trace π is a sequence of instances of visible operations in a concrete execution of the multithreaded program. Each instance is called an event. For Java programs, both read/write accesses to shared variables and the synchronization operations are recorded as events, while invisible operations are ignored. An event is represented as a tuple (tid,type,var,val), where tid is the thread index, type is the event type, var is either a shared variable (in read/write) or a synchronization object, val is either a concrete value (in read/write) or the child thread index (in thread creation/join). The event type is one of {read, write, fork, join, acquire, release, wait, notify, notifyAll}. They can be classified into three categories:
1) read and write denote the read and write access to a shared variable, where var is the variable and val is the concrete value;
2) fork and join denote the creation and termination of a child thread, where (tid, fork, -, val) creates a child thread whose index is val, and (tid, join, -, val) joins the child thread back;
3) the rest correspond to synchronization operations over locks and condition variables. The synchronized keyword is translated into a pair of acquire and release events over the lock implicitly associated with an object.

For an event e and its attribute a, we will use e.a. In addition, given an execution π and an event e in it, e.idx denotes the unique index of event e in n. For example, in event eᵢ: (1,fork,-,2), we have eᵢ.tid=1,eᵢ.type=fork,eᵢ.val=2, and eᵢ.idx=i.

### Partial Order and Linearizations

Let π=e₁ . . . eₙ be a concrete execution. The trace can be viewed as a total order of the set {e₁, . . . , eₙ} of events. To capture all the alternative and yet feasible interleavings of the events in π, we define a partially ordered set, denoted T_{π}=(T, [symbol] ), such that:
T={e/e is an event in T_{π}}.
[symbol] is a partial order such that:
   if eᵢ.tid=eⱼ.tid and eᵢ appears before eⱼ in π, then eᵢ [symbol] eⱼ,
   if eᵢ=(tid₁, fork, -, tid₂) and eⱼ is the first event of thread tid₂ in π, then eᵢ [symbol] eⱼ,
   if eᵢ=(tid₁, join, -, tid₂) and eⱼ is the last event of thread tid₂ in π, then eⱼ [symbol] eᵢ.
   [symbol] is transitively closed.

In the presence of shared variables and synchronization primitives, not all linearizations (total orders) of T_{π} correspond to actual program executions. We define a sequentially consistent linearization τ_{π} of T_{π} as one that satisfies [symbol] as well as the following requirements:
Write-Read Consistency: the value read by an event is always written by the most recent write in τ_{π}, and
Synchronization Consistency: τ_{π} does not violate the semantics of the synchronization events.

The set of all linearizations of T_{π} forms the search space of our witness generation algorithm. That is, we search for a sequentially consistent linearization that leads to a state in which two data-conflict events are both enabled.

Our technique of sequentially consistent linearization considers more than just semaphore as the only synchronization primitive; we also explicitly model thread creation and join (fork and join), and all other Java synchronization primitives. In our symbolic method for searching sequentially consistent linearizations, event is a concrete read or write.

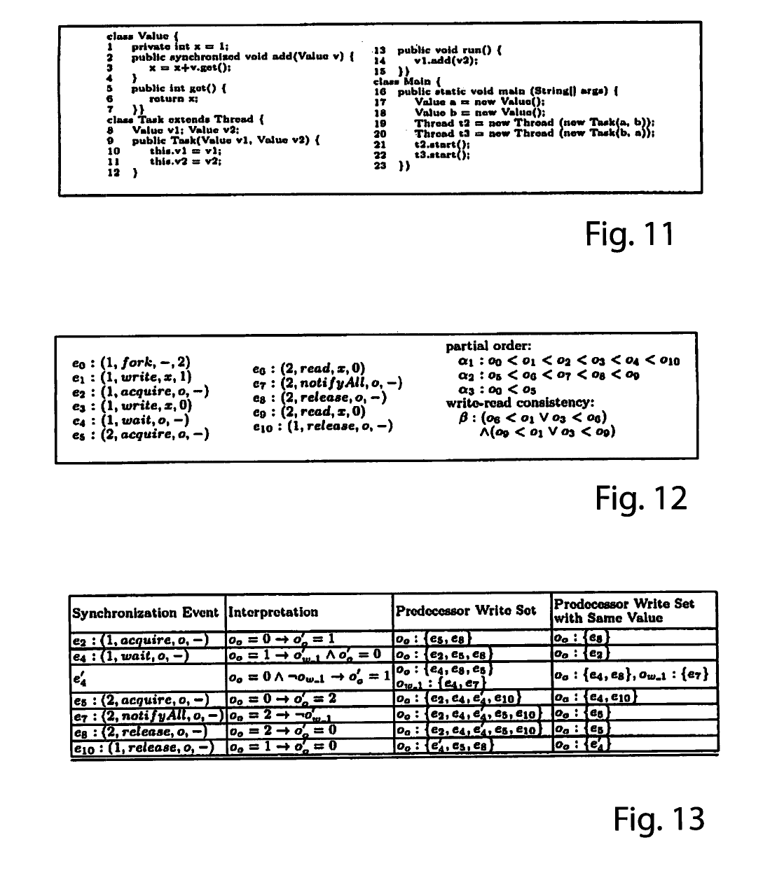

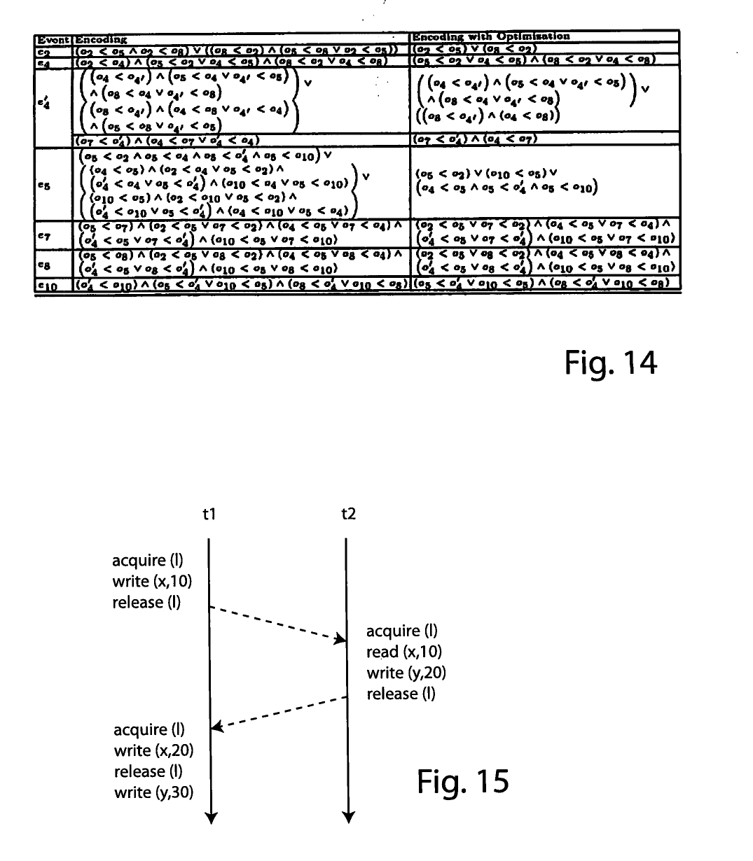

As an example, consider the Java program in FIG. 11. Inside the main method, thread t1 creates threads t2 and t3, which execute methods t1.run( ) and t2.run( ), respectively. The shared variables are a.x and b.x. Note that, according to the Java execution semantics, a.x is aliased to t2.v1.x and t3.v2.x, and b.x is aliased to t2.v2.x and t3.v1.x.

Let Tid={1, 2, 3}. Executing the program may result in the following partial trace, i.e. a subsequence of events from threads t2 and t3 as follows: . . . (2,13-14), (2,2-3), (2,5-7), (2,4), (2,15), (3,13-14), (3,2-3), (3,5-7), (3,4), (3,15), where each event is denoted as a pair of the thread index and the line number(s). During this execution, the shared variable b.x is read by thread t2 at line 6 (aliased as t2.v1.x) and written by thread t3 at line 3 (aliased as t3. v2.x). However, this trace is not a witness of data race because the two aforementioned accesses to b.x are never simultaneously enabled. There exists an alternative interleaving of the same set of events: . . . (2,13-14), (2,2-3), (2,5), (3,13-14), (3,2), (2,6), (3,3), (3,5-7), (3,4),(3,15), (2,7), (2,4), (2,15). It is a data race witness because there exists a state in which the read access by event (2,6) and the write access by event (3,3) are both enabled. It is guaranteed to be an actual program execution because both write-read consistency and synchronization consistency

The goal of our symbolic analysis is to search for witnesses among all sequentially consistent linearizations of T_{π} derived from the concrete execution π. We formulate the data race witness generation problem as a satisfiability problem. That is, we construct a quantifier-free first-order logic formula ψ_{π} such that the formula is satisfiable if and only if there exists a sequentially consistent linearization of T_{π} that leads to a state in which two data-conflict events are both enabled. The formula ψ_{π} is a conjunction of the following subformulas:

ψ_{π}:=α_{π} [symbol] β_{π} [symbol] γ_{π} [symbol] ρ_{π}

In the next section we present a discussion of the symbolic encoding of the write-read consistency. First we explain algorithms to encode the partial order (α_{π}), write-read consistency (β_{π}), and data race property (ρ_{π}) in first-order logic (FOL) formulas. Thereafter we discuss the encoding of synchronization consistency (γ_{π}).

### Encoding the Partial Order

Given a multithreaded trace π, let π|ₜ= [symbol] e₁^{t}, eₙ^{t} [symbol] be a sub-sequence that is a projection of π onto the thread t. Let t.first and t.last be the first and last event of thread t in π, i.e., e₁^{t} and eₙ^{t}, respectively. For each event e, we introduce an event order (EO) variable whose value represents its position in a linearization of T_{π}. To ease our presentation, we assume that an EO variable shares the same unique index with the corresponding event. Therefore o_{e.idx} is the EO variable for e. Let the number of events be |π|. The domain of oᵢ, where 1≦i≦|π|, is [1 . . . |π|]. Furthermore, we have oᵢ≠oⱼ if i≠j.

Equation 13 encodes the partial order requirement of sequentially consistent linearizations of T_{π}. It enforces a total order within each thread-local sequence π|ₜ(1≦t≦N), and enforces the order between the first (or last) event of a thread and the corresponding fork (or join) event, if such event exists. In Equation 13 FORK and JOIN denote the set of fork and join events in T_{π}. For an event e∈FORK, e.val gives the child thread index, thus (t_{e.val}).first.idx is the index of the first event in the child thread.

$$\begin{matrix}{α}_{π} ≡ ( \begin{matrix}{{}_{t = 1}}^{T} ( {o}_{{e}_{1} \cdot idx}^{t} < … < {o}_{{e}_{n} \cdot idx}^{t} ) ⋀ {}_{e ∈ FORK} \\ ( {o}_{e \cdot idx} < {o}_{( {t}_{e \cdot val} ) \cdot first \cdot idx} ) ⋀ {}_{e ∈ JOIN} ( {o}_{( {t}_{e \cdot val} ) \cdot last \cdot idx} < {o}_{e \cdot idx} )\end{matrix} ) & ( Eq . 13 ) \\ {β}_{π} ≡ {}_{e ∈ π e \cdot type = read} ( \begin{matrix}( \begin{matrix}( e \cdot tiwp = null ) ⋀ ( e \cdot val = e \cdot var \cdot init ) ⋀ \\ {}_{e 1 ∈ e \cdot pws} ( {o}_{e \cdot idx} < {o}_{e 1 \cdot idx} )\end{matrix} ) ⋁ \\ {}_{e 1 ∈ e \cdot pwsv} ( {{}_{e 2 ∈ e \cdot pws ⋀ e 2 \neq e 1}}^{( {o}_{e 1 \cdot idx} < {o}_{e \cdot idx} ) ⋀} ( {o}_{e \cdot idx} < {o}_{e 2 \cdot idx} < {o}_{e 1 \cdot idx} ) )\end{matrix} ) & ( Eq . 14 ) \\ {ρ}_{π} ≡ {}_{( e 1 , e 2 ) ∈ PDR} ( ( {o}_{e {1}^{′} \cdot idx} < {o}_{e {2}^{′} \cdot idx} < {o}_{e {1}^{″} \cdot idx} ) ⋀ ( {o}_{e {2}^{′} \cdot idx} < {o}_{e {1}^{′} \cdot idx} < {o}_{e {2}^{″} \cdot idx} ) ) & ( Eq . 15 )\end{matrix}$$

Equation 14 shows an execution trace π with 11 events e₀, . . . , e₁₀ generated by two threads. The last column in FIG. 12 lists the partial order constraints: α₁ and α₂ enforces a total order on the events from thread 1 and 2, respectively; α₃ ensures that the fork event in thread 1 happens before the first event in thread 2.

### Encoding Write-Read Consistency

Given a linearization I, we use e₁ [symbol] _{I}e₂ to denote that event e₁ happens before e₂ in I. Similarly, we use e₁ [symbol] ₜe₂ to denote that e₁ happens before e₂ within the same thread t.

Definition 1. Linearization Immediate Write Predecessor: Given a read event e in a linearization I, we define its linearization immediate write predecessor, denoted as e.liwp, to be a write event e′ [symbol] _{I}e such that e.var=e′.var and there does not exist another write event e″ such that e′ [symbol] _{I}e″ [symbol] _{I}e and e″.var=e.var.

Definition 2. Thread Immediate Write Predecessor: Let nit be the projection of execution π onto thread t. The thread immediate write predecessor to a read event e, denoted as e.tiwp, is a write event e′ [symbol] ₜe in π/ₜ such that e.var=e′.var and there does not exist another write event e″ such that e′ [symbol] ₜ e″ [symbol] ₜ e and e″.var=e.var.

Definition 3. Write-Read Consistency: A linearization I is write-read consistent if and only if for any read event e (1) if there exists a write event e′ such that e′=e.liwp, then e.val=e′.val; (2) if e′ does not exist, then e.val=e.var.init. Here e.var.init is the initial value of variable e.var.

Definition 4. Predecessor Write Set: Given an execution n, the predecessor write set of a read event e, denoted as e.pws is a set that includes any write event e′ such that e′.var=e.var and (1) e′.tid/=e.tid, or (2) e′.tid=e.tid and e′=e.tiwp. The predecessor write of the same value set to a read event e, denoted as e.pwsv, is a subset of e.pws, where for any e′ E e.pwsv, we have e′.val=e.val.

Equation 14 considers all the possible linearizations that satisfy the write-read consistency requirement. For each read event e in π, there are two possible cases:
1. Event e has no thread immediate write predecessor (e.tiwp=null), its read value is the same as the variable's initial value (e.val=e.var.init), and all the write events in the predecessor write set of e happen after e (oₑ.idx<oₑ₁.idx). Note that the two equality constraints evaluate to either true or false statically, and therefore will not be added in the SMT formula.
2. Event e follows a write event e1 in its predecessor write of the same value set (oₑ.idx<oₑ₁.idx), and all other writes to e.var happens either before e1 (oₑ₂.idx<oₑ₁.idx), or after e (oₑ.idx<oₑ₂.idx). This constraint guarantees that e reads the value written by e1 and no other writes can interfere with this write-read pair.

If all the read events satisfy the above constraints, as specified in Equation 14, the linearizations are write-read consistent. Consider the example in FIG. 12. Column 3 shows the write-read constraints, along with some implementation optimizations, described as follows:
1. o₆<o₁ requires that the read event e₆ appears before any write to x. Note that although o₆<o₃ is also required as in Equation 2, it is removed (constant true) because it is implied by (o₆<o₁) together with α₁.

2. o₃<o₆ requires that the read event e₆ happens after e₃. Although the full constraint as in Equation 14 is (o₃<o₆) [symbol] (o₁<o₃ [symbol] o₆<o₁), we remove the second conjunct because o₁<o₃ is implied by α₁.

### Encoding the Data Race

Definition 5. Data Race Witness: An execution π=π₁e₁e₂π₂, where π₁ and π₂ are the trace prefix and suffix, respectively, has a data race on e₁ and e₂ if the two events belong to different threads, access the same shared variable and at least one access is a write.

Let PDR be the set of potential data races in T_{π}, where each data race is represented as a pair (e1, e2) of events that belong to different thread (e1.tid≠e2.tid), access the same variable (e1.var=e2.var), and at least one access is a write (e1.type=write v e2.type=write).

Given every event pair (e1, e2)∈PDR, let e1′ and e1″ be the events immediately before and after e1 in the same thread, and e2′ and e2″ be the events immediately before and after e2 in the same thread. Equation 3 captures the existence of a witness in which e1 and e2 are simultaneously reachable.

We can further reduce the number of data race constraints (currently 4) into 3 by adding o_{e1.idx}<o_{e2.idx}, since it implies the two existing constraints o_{e1′.idx}<o_{e2.idx} and o_{e1.idx}<o_{e2″.idx}. A data race exists in an execution π if e1 is immediately followed by e2 in π. We do not need to consider the dual case that e1 immediately follows e2 because if such linearization exists, since it is guaranteed that the linearization in which e2 follows e1 exists as well.

Having thus explained the symbolic encoding of the write-read consistency, we turn now to an explanation of symbolic encoding of the synchronization consistency

### Synchronization Interpretation

We interpret the semantics of these synchronization operations precisely during symbolic encoding. The interpretation involves replacing object variables with simple-type variables available to SMT solvers, and map the synchronization operations on objects to logic operations on simple-type variables. Although Java allows recursive locks, they happen rarely in executions. An execution π has a recursive lock if there exist two events eᵢ and eⱼ in π such that eᵢ=eⱼ=(t,acquire,o,-) and there is no event (t,release,o,-) in between; otherwise π is called recursive-lock-free. If an execution π is recursive-lock-free, then any sequentially consistent linearization of T_{π} is also recursive-lock-free (a reorder of events within the same thread is not allowed).

We introduce the following simple-type shared variables for each object o.
An integer variable oₒ with domain [0 . . . N] where N is the number of threads. Object o is free if oₒ is 0. Otherwise oₒ is the thread index that owns object o.
N Boolean variables o_{w}_{_{—}}ₜ(1≦t≦N). The value of o_{w}_{_{—}}ₜ is true if and only if thread t is in object o's wait set.

In the following we list the interpretation of the synchronization operations. For each variable v, we use the normal form v to indicate its current value, and use the primed version v′ to indicate its value at the next step.
Event (t,acquire,o,-) is interpreted as oₒ=0→oₒ′=t. It requires that the object is free, and then set the owner of object o to thread t.
Event (t, release, o, -) is interpreted as oₒ=t→oₒ′=0. It requires that the owner of object o is thread t, and then set object o to be free.
Event (t,wait,o,-) is converted into two consecutive atomic events. The first atomic event is interpreted as (oₒ=t→o_{w}_{_{—}}ₜ′ [symbol] oₒ=0), which requires that the owner of thread o is thread t, and then sets object o to free and the flag o_{w}_{_{—}}ₜ′ to true. The second atomic event is interpreted as (oₒ=1 [symbol] [symbol] o_{w}_{_{—}}ₜ)→oₒ′=t, which requires that object o is free and thread t is no longer waiting. For the wait event to complete, a notify or notifyAll event from another thread needs to interleave in between to reset o_{w}_{_{—}}ₜ.
Event (t, notifyAll, o, -) is interpreted as oₒ=t→ [symbol] _{t1∈o.wait} [symbol] o_{w}_{_{—}}ₜ₁, where o.wait is the set of threads waiting on object o. It requires that the owner of o is thread t, and then reset o_{w}_{_{—}}ₜ₁ for any waiting thread t1.
Event (t,notify,o,-) requires that one and only one thread waiting on o, if any, is woken up. We introduce N auxiliary variables H_{w}_{ₜ} with domain {0,1}, one for each thread t∈Tid, such that (1) H_{w}_{_{—}}ₜ must have value 0 if thread t is not waiting for on o and (1) exactly one H_{w}_{_{—}}ₜ has value 1 if the waiting set for o is not empty. The requirement can be obtained by the following constraints:

[symbol]

_{1≦t≦N}( [symbol] o_{w}_{_{—}}ₜ→ [symbol] H_{w}_{_{—}}ₜ=0)

( [symbol] _{1≦t≦N}o_{w}_{_{—}}ₜ)→(Σ_{1≦t≦N}H_{w}_{_{—}}ₜ=1)

Finally, the notify event is interpreted as:

[symbol]

_{t∈Tid}(H_{w}_{_{—}}ₜ=1→ [symbol] o_{w}_{_{—}}ₜ′ [symbol] H_{w}_{_{—}}ₜ=0→o_{w}_{_{—}}ₜ′=o_{w}_{_{—}}ₜ)

which states that thread t is no longer waiting on object o if it is chosen; otherwise its waiting status remains the same.

### The Recursive-Lock-Free Encoding

In this section we present the constraints the enforce synchronization consistency for recursive-lock-free multithreaded traces. The first two columns in the table of FIG. 13 give the interpretation of the synchronization events in FIG. 12. The original wait event e₃ is split into two new events: e₃ and its shadow event e₃′. Correspondingly we introduce an event order variable o₃′ and adds partial order constraint o₃<o₃′<o₄.

Definition 6. Initial Value: The initial value v.vi, is defined as follows: (1) the value for a variable oₒ that denotes the ownership of an object is 0, i.e. oₒ.iv=0, (2) the value for a variable that denotes whether thread t is waiting for an object is false, i.e. o_{w}_{_{—}}ₜ.iv=false for 1≦t≦N.

Assumed Value: The assumed value of a variable v in a synchronization event e in the format of assume→update, denoted vₑ.av, is the value specified in the sub-formula e.assume. Here v is called an assumed variable in e, and e.assume is the set of assumed variables in e.

Written Value: The written value of a variable v in a synchronization event e in the format of assume→update, denoted as vₑ.wv, is the value specified in the sub-formula e.update. v is called an updated variable in e, and e.updated is the set of updated variables in e.

$${γ}_{e} ≡ {}_{v ∈ e . assume} ( \begin{matrix}( {v}_{e} \cdot av = v \cdot iv ⋀ {v}_{e} first ⋀ {}_{{e}_{1} ∈ {v}_{e} \cdot pws} {o}_{e \cdot idx} < {o}_{{e}_{1} \cdot idx} ) ⋁ \\ {}_{{e }_{1} ∈ {v}_{e} \cdot pwsv} ( {{}_{{e}_{2} ∈ {v}_{e} \cdot pws ⋀ {e}_{2} \neq {e}_{1}}}^{( {o}_{e \cdot idx} < {o}_{{e}_{1} \cdot idx} ) ⋀} ( \begin{matrix}{o}_{e \cdot idx} < {o}_{{e}_{2} \cdot idx} ⋁ \\ {o}_{{e}_{2} \cdot idx} < {o}_{{e}_{1} \cdot idx}\end{matrix} ) )\end{matrix} ) \qquad ( Eq . 16 )$$

Given a synchronization event e, Equation 16 enforces a valid position in any linearization for e with respect to other synchronization events. It considers each assumed variable v in e, and adds constraints on the position of e based on the v's assumed value:
If v's assumed value in e, vₑ.av, is the same as v's initial value v.iv, then e can be in a position that is before any write to v. That is,

$${}_{{e}_{1} ∈ {v}_{e} \cdot pws} {o}_{e \cdot idx} < {o}_{{e}_{1} \cdot idx}$$

Note that if there exist writes to v before e from the same thread, this constraint contradicts the partial order constraint thus becomes false.
Event e follows an event e₁∈vₑ.pwsv. In this case e happens after e₁(o_{e1.idx}<o_{e.idx}) so the assumed value at e can take updated value at e′, and other events that write to v do not interfere by happening either before the write at e₁ or after the read at e.

Column 3 and 4 in the table of FIG. 12 list the predecessor write set of the shared variables oₒ and o_{w}_{_{—}}₁ and its subset, predecessor write with the same value set, respectively. The table of FIG. 13 gives the encoding based on Equation 16. Although in Equation 16 there is a constraint:

$$( {v}_{e} \cdot av = v , iv ⋀ {}_{{e}_{1} ∈ {v}_{e} \cdot pws} {o}_{e \cdot idx} < {o}_{{e}_{1} \cdot idx} ) ,$$

the constraint can be removed if [symbol] 's value is not the same as the initial value, or be reduced to

$${}_{{e}_{1} ∈ {v}_{e} \cdot pws} {o}_{e \cdot idx} < {o}_{{e}_{1} \cdot idx}$$

if the values are the same. In addition, several other straightforward optimizations can be applied. Column 3 gives more concise en-coding than Column 2 due to the following optimizations:
   A sub-formula s that can be implied by partial order constraint. For example, o₆<o₉ in e₁ and o₁<o₃ in e₃. This reduces s [symbol] s′ to s, and s [symbol] s′ to true.
   A sub-formulas s that contradicts partial order constraint. For example, o₃′<o₃ in e₄ and o₅<o₃ in e₆. This reduces s [symbol] s′ to s.
   A sub-formula s that is weaker than s′ in s [symbol] s′. For example, in o₁<o₆ [symbol] o₁<o₉ in e₁, o₁<o₉ can be removed because o₆<o₉.
Finally the synchronization consistency constraint is specified by γ_{π}≡ [symbol] , where e is a synchronization event in π.
   Encoding with Recursive Locks

If an execution π has recursive locks, we define a variable depthₒ^{t} that denotes the depth of object o that has been locked by thread t. The initial value of depthₒ^{t} is 0. For each sequence π|ₜ that is a projection of π on thread t, we increase the value of depthₒ^{t} by 1 for each (t, acquire, o, -), and decrease the value by 1 for each (t, release, o, -). Depending on the value of depthₒ^{t}, acquire and release events are encoded differently as the following:
An event e: (t, acquire, o, -) is called the first acquire event if e.depthₒ^{t}=0. Its corresponding constraint is oₒ=0→oₒ′=t.
For event e: (t, acquire, o, -) that is not a first acquire event, its corresponding constraint is oₒ=t→oₒ′=t.
An event e: (t, release, o, -) is called the last release event if e.depthₒ^{t}=0. Its corresponding constraint is oₒ=t→oₒ′=0.
For event e: (t, release, o, -) that is not a last release event, its corresponding constraint is oₒ=t→oₒ′=t.

We do not need to explicitly record the depth of recursive locks. It is based on the observation that (1) π is a valid execution, thus the number of acquire and release events must be balanced; and (2) The depths of recursive locks associated with an acquire or release event (a thread-local property) will not be changed by thread interleavings.

### Correctness and Complexity

Theorem 1. Let π be the given multithreaded trace. There exists a data race witness in a sequentially consistent linearization of T_{π} if and only if ψ_{π} is satisfiable:

ψ_{π}≡α_{π} [symbol] β_{π} [symbol] γ_{π} [symbol] ρ_{π}

According to the definitions of partial order constraint α_{π}, write-read consistency constraint β_{π}, and synchronization consistency constraint γ_{π}, a linearization of T_{π} that satisfies α_{π} [symbol] β_{π} [symbol] γ_{π} is sequentially consistent. Since the events are all from a real execution, a sequentially consistent linearization represents events from a valid execution as well. In addition, the definition of data race property enforces that in the linearization there are two adjacent events (at least one is a write event) from different threads accessing the same variable.

Our approach eliminates the bogus warnings reported by typical data race detection algorithms, e.g. those based on lock-set analysis. Consider the execution shown in FIG. 15 where x,y are shared variables with initial value 0. A lock-set analysis will reports a data race warning between the two write events to y as one of them is not protected by any lock. Our approach will not produce a data race witness because write-read consistency enforces the read event of x in thread 2 must happen between the two write events to x in thread 1. In addition, each corresponding acquire-release pair is atomic according the synchronization constraints. Therefore the two write events are never enabled at the same time.

For most Java executions the number of synchronization events is very small compared with the number of total events. Since the majority of the constraints are generated from encoding read, write events and data race properties, their complexity determines the scalability of our approach. We note that these constraints are in pure integer difference logic (IDL)—an efficiently decidable subset of FOL where each IDL constraint is of the form (x−y≦c), where x and y are integer variables and c is 0.

### Static Optimizations

In the implementation, we use the incremental feature of the Yices SMT solver [5]. We divide the constraints in ψπ into two parts: ψ_{π}=(α_{π} [symbol] β_{π} [symbol] γ_{π}) [symbol] ρ_{π}, where the first part encodes all the sequentially consistent linearizations, and the second part states that a data race exists. Let ρ_{π} be a conjunction of subformulas ρ_{π}(eᵢ,eⱼ), each of which states the simultaneous reachability of an event pair (eᵢ, eⱼ)∈PDR. Instead of building and checking ρ_{π} in one step (same as combining all potential data races in one check), we check each individual event pair in isolation. The incremental SAT procedure is as follows.

Within the SMT solver, we first construct the subformula (α_{π} [symbol] β_{π} [symbol] γ_{π}).

Then for the first data race event pair we construct ρ_{π}(eᵢ,eⱼ) and add this subformula as a retractable assertion. The retractable assertion can be re-moved after satisfiability checking, while allowing the SMT solver to retain the lemmas (clauses) learned during the process. If the result is satisfiable, then the SMT solver returns a satisfying assignment (witness); otherwise,

such witness does not exists.

After retracting the first assertion ρ_{π}(eᵢ,eⱼ), we construct ρ_{π}(eᵢ′,eⱼ′) for the second event pair (eᵢ′,eⱼ′) and add it to the SMT solver.

We keep repeating steps 2 and 3 till all the event pairs in PDR are checked. The benefit of using incremental SAT is reducing the overall runtime by sharing the cost of checking different data races. Although it might appear to be costly to call the SMT solver once for each potential data race in PDR, the entire process turns out to be efficient because of incremental SAT. Often the first few SAT calls take a significant portion of the total runtime; after that, the “learned clauses” accumulated inside the SMT solver make the subsequent SAT calls extremely fast.

Typical data race detection algorithms (e.g. those based on locksets) have false alarms—sometimes many of them, which means the input to our witness generation algorithm, the set PDR of (potential) data races, may have event pair (eᵢ, eⱼ) such that eᵢ, eⱼ are not simultaneously reachable. Therefore, it is often advantageous to check, before calling the precise SMT analysis, whether (eᵢ,eⱼ) simultaneously reachable by using a conservative analysis. Our analysis is based on statically computing the following information: (1) lock acquisition histories [14]; (2) must-happen-before constraints, where event e₁ must happen before e₂ if and only if that is the case in every linearization of T_{π}. This analysis is in general comparable to and sometimes more precise than standard data race detectors.

### Experiments

We have implemented the described method and conducted experiments on some public benchmarks. We collected traces using a Java agent interface that captures the Java Virtual Machine Execution events. Our symbolic analysis is implemented using the Yices SMT solver. All benchmark programs are accompanied by test cases to facilitate the concrete execution. Our experiments were conducted on a workstation with 2.8 GHz processor and 2 GB memory.

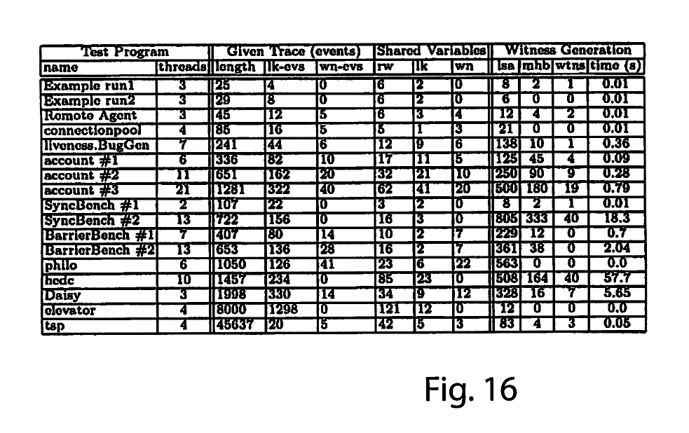

The table of FIG. 16 shows the experimental results. Among the benchmarks, Example (run 1) is the simple example illustrated in FIG. 11, Example (run 2) is the same example except that the get method is synchronized. All other benchmarks are publicly available in [12, 20, 11, 19, 8]. The first two columns show the statistics of the test program, including the name and the number of threads. The next three columns show the statistics of the given trace, including the length (visible events only), the number of acquire/release events, and the number of wait/notify/notifyAll events. The next three columns show the number of data variables (rw), the number of lock variables (lk) and the number of condition variables (wn) in the trace. The last four columns show the statistics of the symbolic witness generation algorithm, including the number of potential data races after the lock acquisition history analysis (lsa), the number of potential data races after the must-happen-before analysis (mhb), the number of witnesses generated (wtns), and the runtime of our symbolic algorithm in seconds. During symbolic witness generation, we call the SMT solver incrementally, one at a time, only for the potential data races in the column mhb. The runtime in seconds is the combined processing time for all these potential data races.

In almost all cases, our static pruning based on lock acquisition history and must-happen-before constraints is able to reduce the number of potential data races significantly, therefore reducing the burden on the symbolic algorithm. We also note that, even after pruning, most of the potential data races do not have concrete witnesses—they are likely to be bogus errors. This result highlights the problem associated many data race detection algorithms in the literatures. Reporting such data races (warnings) directly to programmers could be counter-productive in practice, since it imposes significant burden (manual effort) on the programmers for deciding whether a reported data race is real.

The runtime results show that our witness generation algorithm scale to medium length traces, and is fast enough to be used as a post-mortem analysis.

### CONCLUSION

Despite that numerous static and dynamic techniques exist to detect data races, few are capable of providing witnesses to help programmers understand how a data race can happen during program execution. In this paper we propose a SMT-based symbolic method to produce concrete witnesses for data races in concurrent programs. Our tool can be integrated seamlessly with traditional testing procedure because of the following reasons: (1) the inputs to our tool are ordinary program execution traces, (2) our approach amplifies the effectiveness of each testing run by considering all the alternative event interleavings, (3) the witnesses produced by our tool pinpoint data races and thus help programmers better understanding the erroneous behaviors. Our experimental results show that the proposed algorithm is scalable enough for a post-mortem analysis.

The methods described here can be implemented as an apparatus or programming tool, used by programmers to debug and evaluate multithreaded programs. As such, the computer-implemented methods and processor configurations can be incorporated into a multipurpose tool (or a suite of tools) that is also used to debug sequential programs, e.g., programs which may not necessarily spawn multiple threads. In such a multipurpose tool, the methods and apparatus described here could be deployed to evaluate multithreaded programs, and the sequential debugging tools could also be deployed, if required, to test other aspects of the multithreaded program as well as to test sequential programs.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of testing for presence of a bug in a multithreaded computer program undergoing verification, comprising:
using a computer to execute the multithreaded program undergoing verification under predefined input conditions;
using a computer to construct a trace comprising a sequence of events performed by the computer during execution of the multithreaded program undergoing verification;
using a computer to encode the trace as a first order logic formula and to store said first order logic formula in memory;
using a computer to access the first order logic formula stored in memory and to apply a satisfiability modulo theory (SMT) solver to the first order logic formula to determine if the first order logic formula is solvable; and
if the first order logic formula is solvable, generating a report that a bug is present in the multithreaded program undergoing verification.

2. The method of claim 1 wherein the first order logic formula is an under-approximation formula.

3. The method of claim 1 wherein the step of encoding the trace as a first order logic formula includes at least one of the following under-approximation encoding constraints:
a) a program transition constraint that expresses the effect of executing a particular statement of the multithreaded program undergoing verification by a particular thread;
b) an initial condition constraint that specifies the starting locations for each thread of the multithreaded program undergoing verification as well as the initial values of program variables;
c) a trace enforcement constraint that restricts the encoded behavior to include only the statements appearing in an executed trace;
d) a thread control constraint that insures that the local state of a thread remains unchanged when the thread is not executing;
e) a thread control constraint that insures that the local state of a thread cannot be selected for execution after it has terminated;
f) a property constraint that indicates the correctness conditions expressed as assertions within the multithreaded program undergoing verification.

4. The method of claim 1 wherein the first order logic formula is an over-approximation formula.

5. The method of claim 1 wherein the step of encoding the trace as a first order logic formula includes at least one of the following over-approximation encoding steps:
a) using a computer to remove a trace enforcement step that prohibits any trace from being considered;
b) using a computer to collapse multiple occurrences and thereby consider only one instance in a transition constraint;
c) using a computer to add control flow constraints for unexecuted statements in the multithreaded program undergoing verification.

6. The method of claim 1 further comprising:
if the first order logic formula is not solvable by the SMT solver, using a computer to encode the trace as a different first order logic formula stored in memory using an over-approximation formula and then
using a computer to access the different first order logic formula stored in memory and to apply the SMT solver to the different first order logic formula to determine if the different first order logic formula is solvable; and
if the different first order logic formula is not solvable, generating a report that no bug was detected in the multithreaded program undergoing verification.

7. The method of claim 6 wherein the over-approximation formula is applied:
a) using a computer to remove a trace enforcement step that prohibits any trace from being considered;
b) using a computer to collapse multiple occurrences and thereby consider only one instance in a transition constraint;
c) using a computer to add control flow constraints for unexecuted statements.

8. The method of claim 1 further comprising:
if the first order logic formula is not solvable by the SMT solver:
a) using a computer to encode the trace as a different first order logic formula stored in memory using an over-approximation formula and then
b) using a computer to access the different first order logic formula stored in memory and to apply the SMT solver to the different first order logic formula to determine if the different first order logic formula is solvable; and
c) if the different first order logic formula is solvable, then using a computer to execute the multithreaded program undergoing verification under a thread schedule that differs from the thread schedule used when the different first order logic formula was found solvable by the SMT solver.

9. The method of claim 1 wherein the trace is constructed by interfacing with the multithreaded program as it executes.

10. The method of claim 1 wherein the trace is constructed by using an agent to access execution events from a virtual machine.

11. The method of claim 1 further comprising using a computer to organize the sequence of events into a plurality of partially ordered sets and then encoding the ordered sets to define the first order logic formula.

12. The method of claim 1 further comprising encoding the trace as a first order logic formula that includes at least one of the following subformulas:
a) partial order;
b) write-read consistency;
c) data race property; and
d) synchronization consistency.

13. An apparatus for testing for presence of a bug in a multithreaded computer program undergoing verification, comprising:
a processor that executes the multithreaded program under verification and that captures and stores in memory a trace log corresponding to a sequence of events performed as the multithreaded program under verification is executed;
a processor that encodes the trace log as an initial first order logic formula, said formula being stored in memory; and
a processor that accesses the initial first order logic formula stored in memory and applies a satisfiabillity modulo theory (SMT) solver to the initial first order logic formula to determine if the initial first order logic formula is solvable, and if solvable, generating a report that a bug is present in the multithreaded program undergoing verification.

14. The apparatus of claim 13 wherein the first order logic formula is an under-approximation formula.

15. The apparatus of claim 13 wherein the processor that encodes the trace log as an initial first order logic formula applies at least one of the following under-approximation encoding constraints:
a) a program transition constraint that expresses the effect of executing a particular statement of the multithreaded program undergoing verification by a particular thread;
b) an initial condition constraint that specifies the starting locations for each thread of the multithreaded program undergoing verification as well as the initial values of program variables;
c) a trace enforcement constraint that restricts the encoded behavior to include only the statements appearing in an executed trace;
d) a thread control constraint that insures that the local state of a thread remains unchanged when the thread is not executing;
e) a thread control constraint that insures that the local state of a thread cannot be selected for execution after it has terminated;
f) a property constraint that indicates the correctness conditions expressed as assertions within the multithreaded program undergoing verification.

16. The apparatus of claim 13 wherein the initial first order logic formula is an over-approximation formula.

17. The apparatus of claim 13 wherein the processor that encodes the trace log as an initial first order logic formula applies at least one of the following over-approximation encoding operations:
a) removing a trace enforcement step that prohibits any trace from being considered;
b) collapsing multiple occurrences to thereby consider only one instance in a transition constraint;
c) adding control flow constraints for unexecuted statements in the multithreaded program undergoing verification.

18. The apparatus of claim 13 further comprising:
a processor that encodes the trace as a different first order logic formula stored in memory using an over-approximation formula if the initial first order logic formula is not solvable upon application of the SMT solver.

19. The apparatus of claim 18 further comprising:
a processor that accesses the different first order logic formula stored in memory and applies the SMT solver to the different first order logic formula to determine if the different first order logic formula is solvable; and if not solvable, generating a report that no bug was detected in the multithreaded program undergoing verification.

20. The apparatus of claim 13 further comprising a processor that encodes the trace log as a first order logic formula that includes at least one of the following subformulas:
a) partial order;
b) write-read consistency;
c) data race property; and
d) synchronization consistency.
